(19) United States
(12) Patent Application Publication
(10) Pub. No.: US 2025/0318975 A1
(43) Pub. Date: Oct. 16, 2025

(54) Cremation Urn with Tilted Display

(71) Applicant: Fayanna Smith, Johnsburg, IL (US)

(72) Inventor: Fayanna Smith, Johnsburg, IL (US)

(21) Appl. No.: 19/177,094

(22) Filed: Apr. 11, 2025

Related U.S. Application Data
(63) Continuation-in-part of application No. 29/937,013, filed on Apr. 11, 2024, now Pat. No. D1089937.
(60) Provisional application No. 63/632,945, filed on Apr. 11, 2024.

(51) Int. Cl. A61G 17/08

(52) U.S. Cl. CPC A61G 17/08

(57) ABSTRACT

A cremation urn with tilted display is a device that enables the ornamental features of the cremation urn to be visible from different angles. The device includes an urn enclosure, an urn base, and an urn hatch. The urn enclosure is designed to retain the desired cremated remains inside the device a safe manner. The urn enclosure can be designed with different shapes and sizes to retain different amounts of cremated remains. The urn enclosure can also be decorated with different ornamental features. The urn base is designed to elevate portions of the urn enclosure in order to orient the urn enclosure at specific angles. The urn base also provides mechanical means to enable the user to fill the urn enclosure with the desired cremation remains. Further, the urn hatch allows the user to seal the urn base to keep the cremated remains safely stored within the urn enclosure.

The current application is a continuation-in-part (CIP) application of the U.S. design application Ser. No. 29/937,013 filed on Apr. 11, 2024.

The current application also claims a priority to a U.S. provisional application Ser. No. 63/632,945 filed on Apr. 11, 2024.

### FIELD OF THE INVENTION

The present invention relates generally to funerary equipment and display devices. More specifically, the present invention discloses a cremation urn with a seated inclined base that allows the ornamental decorations on the cremation urn to be displayed for better visibility.

### BACKGROUND OF THE INVENTION

In general, cremation urns are storage containers designed to safely retain the cremated remains of deceased people. Cremation urns can be designed to be buried or stored above ground in a structure such as a columbarium. Alternatively, cremation urns can also be designed to be publicly displayed. For example, many cremation urns are displayed on a mantle or similar elevated furniture. Most of these cremation urns are designed in the form of a vase or similar vertical structure. Other cremation urns are designed with a horizontal structure, such as rectangular urns. Further, most cremation urns are decorated with an ornamental design that embellishes the external look of the urn. While the ornamental design of vertical urns can be more easily seen by people from different angles, the ornamental designs of horizontal urns can be harder to be seen from different angles. This can be especially difficult when the horizontal urn is at an elevated position where the top of the cremation urn cannot be easily seen. Thus, there is a need for a better urn structural design that enables the ornamental design of the urn to be easily seen by the user.

### SUMMARY OF THE INVENTION

The present invention discloses a cremation urn with tilted display. The cremation urn of the present invention is designed to facilitate the display of the urn at an inclined angle. This way, people can better observe the ornamental features of the urn from different angles. The cremation urn can include different shapes and sizes to accommodate different amounts of cremated remains. For example, the cremation urn may include a heart-shaped design or a wavy rectangular design. In addition, the cremation urn with tilted display includes a drop-in threaded hatch in the base that allows the filling of the cremation urn with the cremated remains. Further, the drop-in hatch creates a secure seal that prevents any retained cremated remains from escaping the cremation urn. Additional features and benefits of the present invention are further discussed in the sections below.

### BRIEF DESCRIPTION OF THE DRAWINGS

FIG. 1 is a top-front-left perspective view of a first embodiment of the present invention.

FIG. 2 is a bottom-front-left perspective view of the first embodiment of the present invention.

FIG. 3 is a top view of the first embodiment of the present invention.

FIG. 4 is a right view of the first embodiment of the present invention.

FIG. 5 is a top-front-left perspective view of a second embodiment of the present invention.

FIG. 6 is a bottom-rear-right perspective view of the second embodiment of the present invention.

FIG. 7 is a top-front-left exploded perspective view of the second embodiment of the present invention.

FIG. 8 is a bottom-rear-right exploded perspective view of the second embodiment of the present invention.

FIG. 9 is a front view of the second embodiment of the present invention.

FIG. 10 is a vertical cross-sectional view of the second embodiment of the present invention taken along line 10-10 in FIG. 9.

### DETAILED DESCRIPTION OF THE INVENTION

All illustrations of the drawings are for the purpose of describing selected versions of the present invention and are not intended to limit the scope of the present invention.

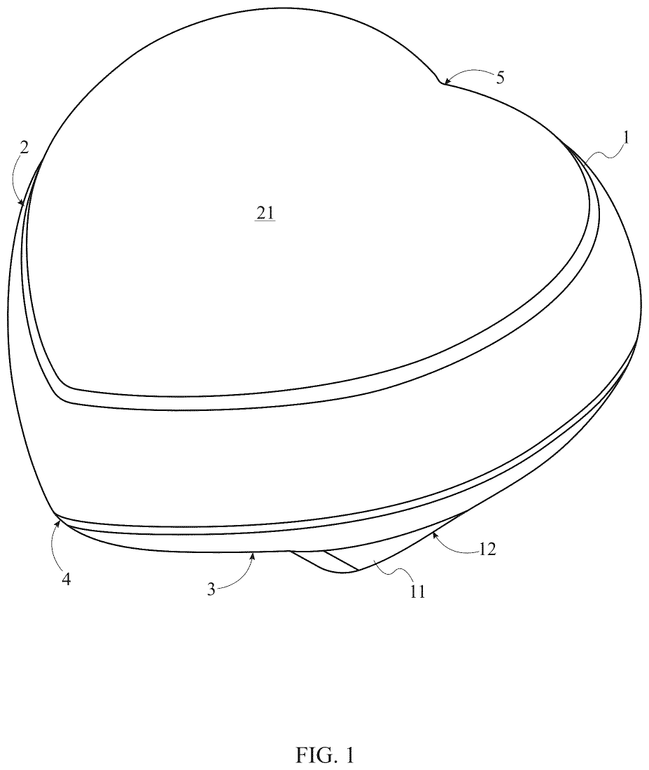

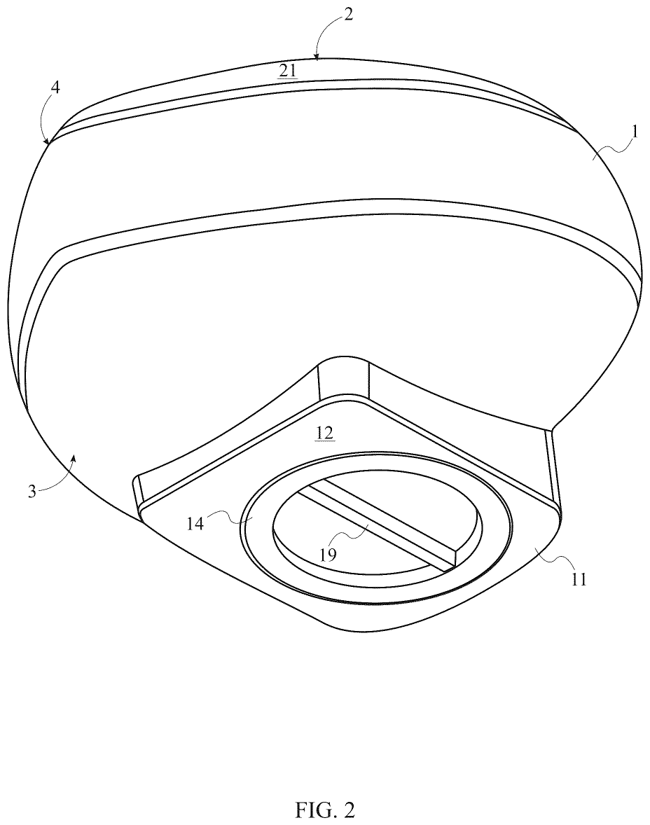

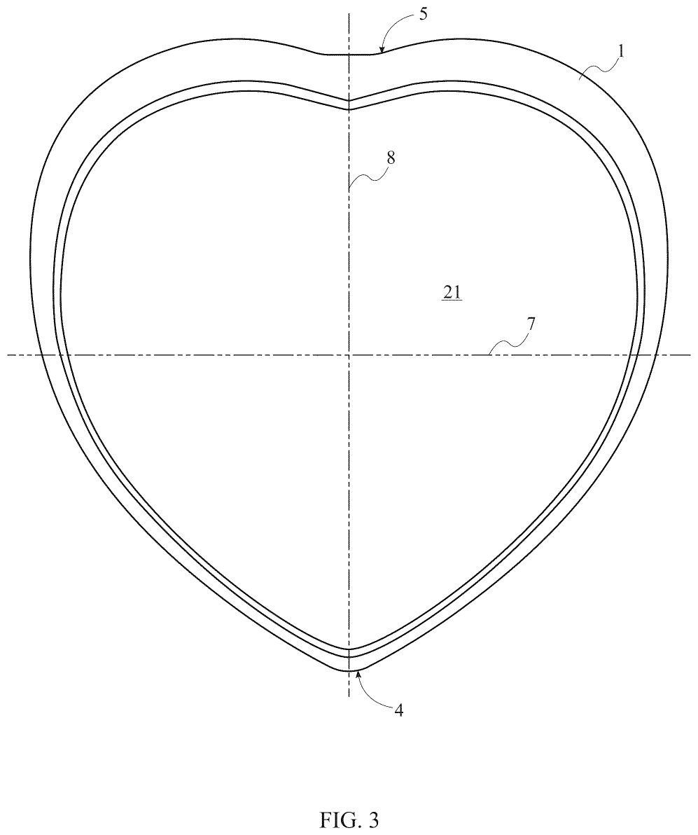

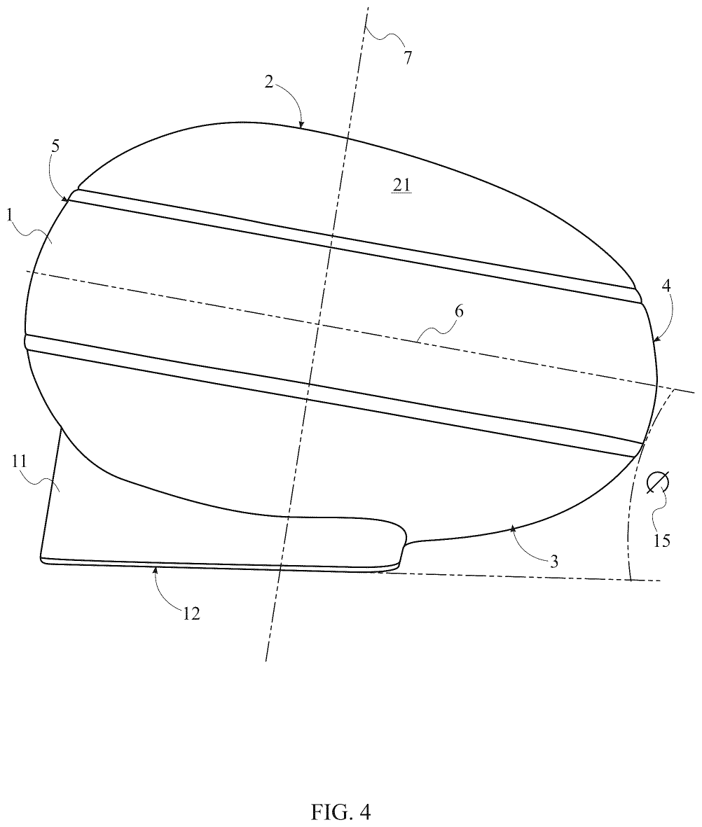

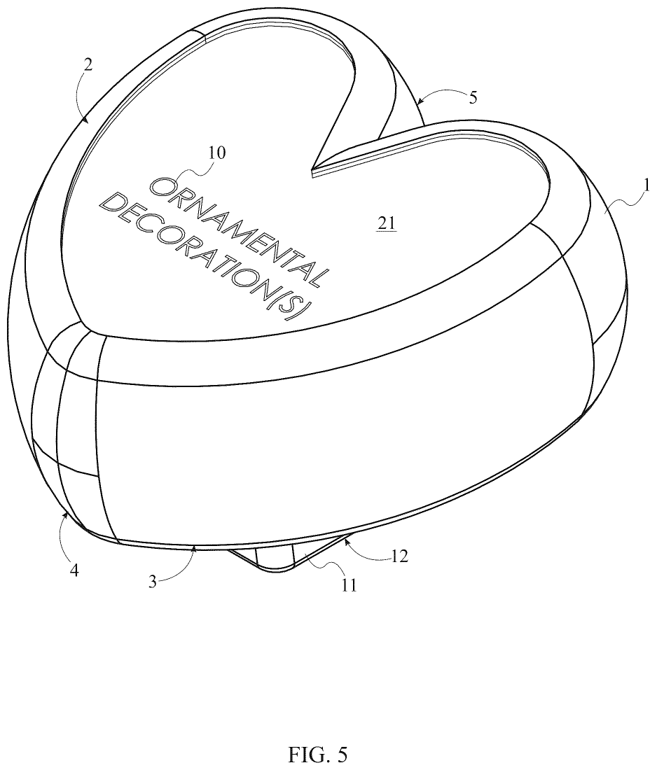

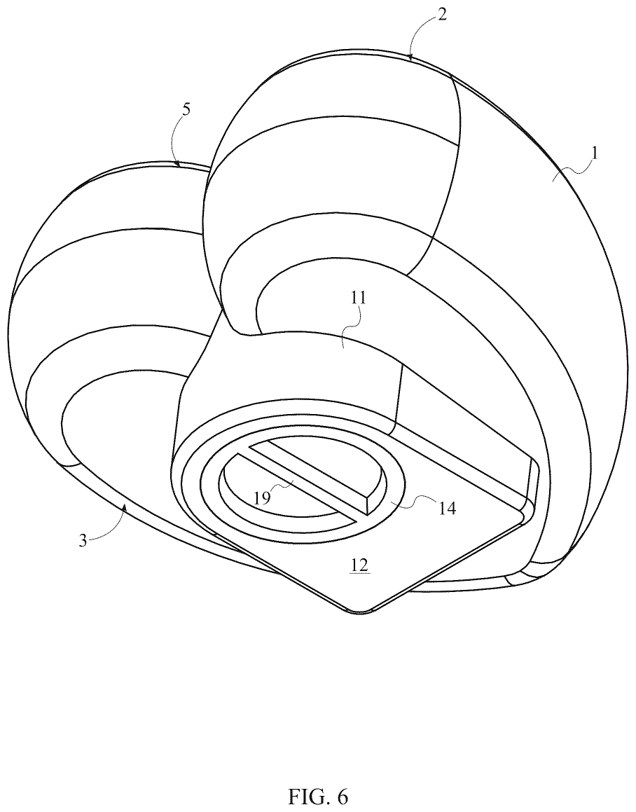

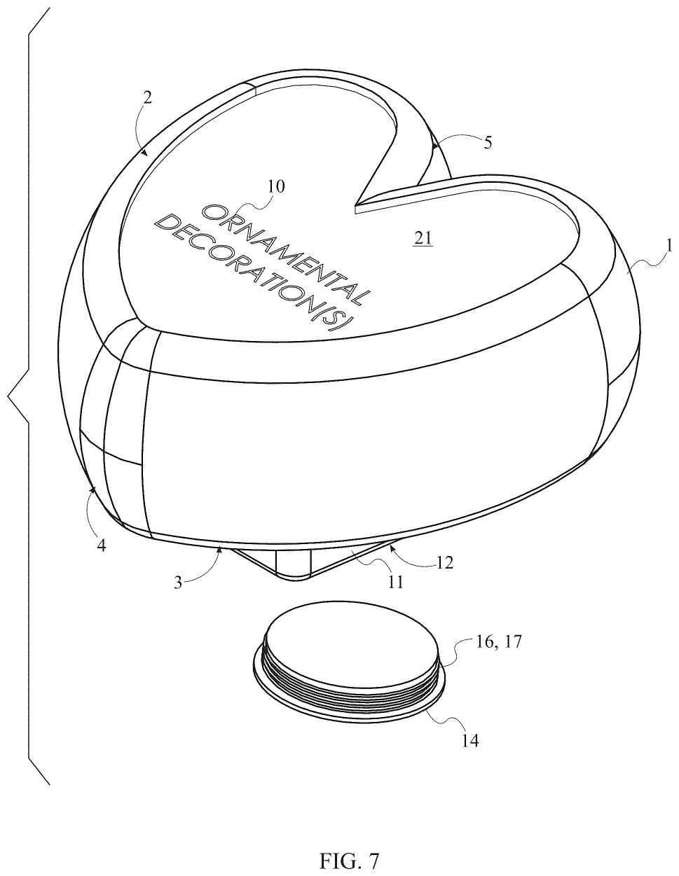

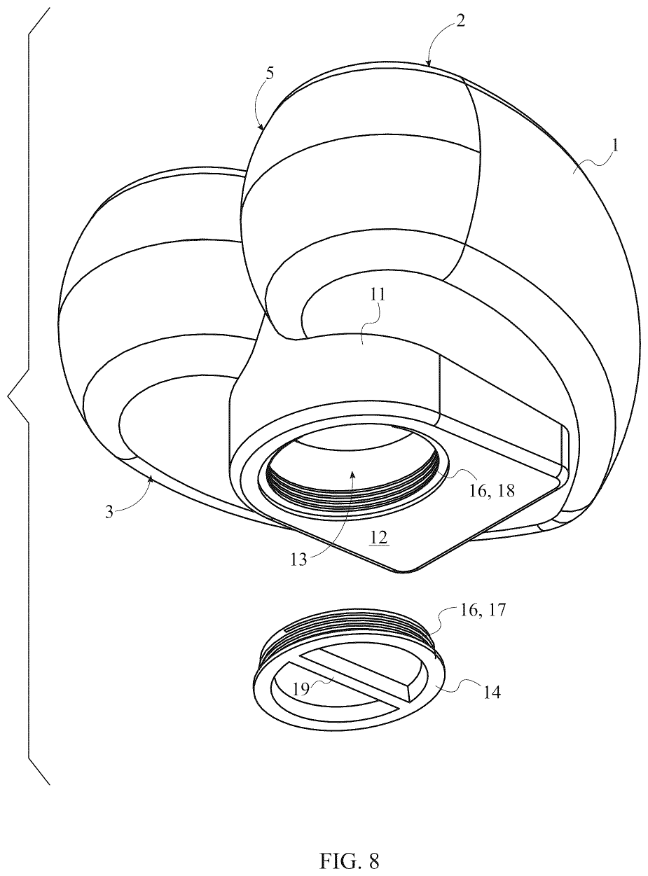

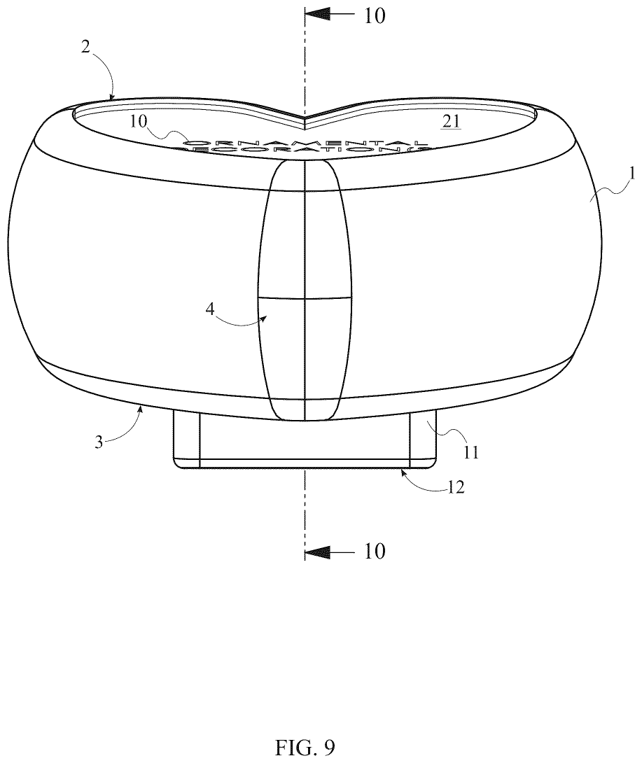

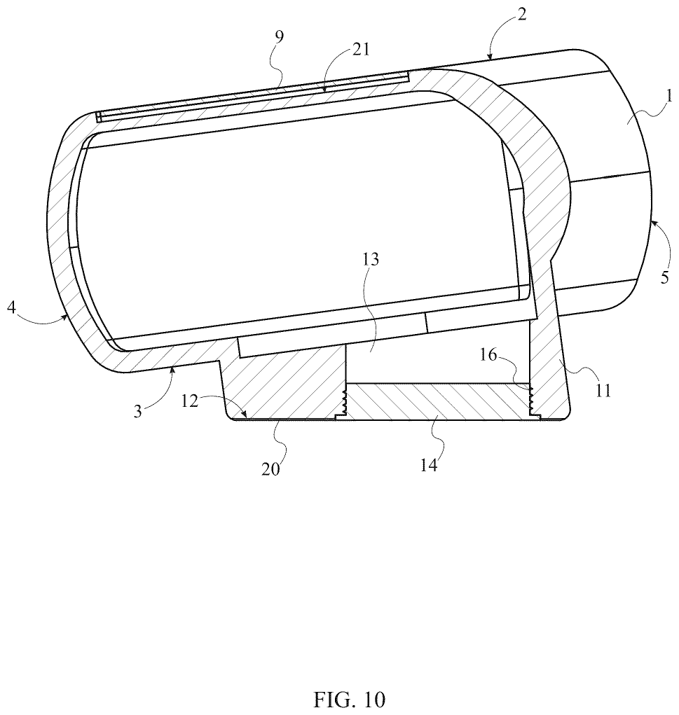

The present invention discloses a cremation urn with tilted display that enables the ornamental features of the cremation urn to be more visible from different angles. As can be seen in FIGS. 1 through 10, the present invention comprises an urn enclosure 1, an urn base 11, and an urn hatch 14. The urn enclosure 1 is designed to retain the desired cremated remains in a safe manner. The urn enclosure 1 can be designed with different shapes and sizes to retain different amounts of cremated remains. The urn enclosure 1 can also be decorated with different ornamental features. The urn base 11 is designed to elevate portions of the urn enclosure 1 in order to orient the urn enclosure 1 at specific angles. The urn base 11 also provides mechanical means to enable the user to fill the urn enclosure 1 with the desired cremation remains. Further, the urn hatch 14 allows the user to seal the urn base 11 to keep the cremated remains safely stored within the urn enclosure 1.

The general configuration of the aforementioned components enables the user to position the cremation urn in a better orientation for people to see the cremation urn safely retaining the cremated remains of a loved one. As can be seen in FIGS. 1 through 10, the urn enclosure 1 can be designed with different shapes and sizes that can hold different amounts of cremated remains. The overall ornamental design can also be customized according to the user's preferences. For example, the urn enclosure 1 can have an overall heart-shaped design or rectangular-shaped design with different ornamental decorations. For example, the heart-shaped urn enclosure 1 design can include a lateral ornamental engraving, while the rectangular-shaped urn enclosure 1 design can include a wave ornamental look that resembles a flag. In addition, the heart-shaped enclosure version of the urn enclosure 1 is bisected by a sagittal plane 8 of the urn enclosure 1. In other embodiments, different designs or ornamental looks can be implemented into the urn enclosure 1.

In general, to retain the cremated remains, the urn enclosure 1 is preferably a hollow structure with walls strong enough to securely hold the weight of the cremated remains stored within the urn enclosure 1. As can be seen in FIGS. 1 through 10, the urn enclosure 1 generally comprises an upper enclosure section 2, a lower enclosure section 3, a front enclosure section 4, and a rear enclosure section 5. The upper enclosure section 2 and the lower enclosure section 3 correspond to the largest opposite surfaces of the urn enclosure 1. The front enclosure section 4 and the rear enclosure section 5 correspond to two lateral and opposite sections of the urn enclosure 1. Further, the urn enclosure 1 can be made from different materials that protect the stored cremated remains. For example, the urn enclosure 1 can be made from different metals, plastics, alloys, or a combination thereof.

Further, the urn base 11 can include a structural design that matches the ornamental design of the urn enclosure 1, as can be seen in FIGS. 1 through 10. For example, the urn base 11 can be a rectangular base large enough to elevate the urn enclosure 1 from the surface. So, the urn base 11 generally comprises a flat bottom surface 12 and a base channel 13. The flat bottom surface 12 corresponds to a large external surface of the urn base 11 that engages the surface on which the cremation urn is placed. The base channel 13 corresponds to a through hole in the urn base 11 that allows the insertion of the cremation remains into the urn enclosure 1.

In the preferred embodiment, the present invention can be arranged as follows: the upper enclosure section 2 and the lower enclosure section 3 are positioned opposite to each other about a transverse plane 6 of the urn enclosure 1, as can be seen in FIGS. 1 through 10. In other words, the upper enclosure section 2 and the lower enclosure section 3 are delimited by the transverse plane 6 of the urn enclosure 1. Similarly, the front enclosure section 4 and the rear enclosure section 5 are positioned opposite to each other about a coronal plane 7 of the urn enclosure 1. In other words, the front enclosure section 4 and the rear enclosure section 5 are delimited by the coronal plane 7 of the urn enclosure 1. Further, the urn base 11 is integrated into the lower enclosure section 3, adjacent to the rear enclosure section 5, to implement the urn base 11 on the urn enclosure 1. In addition, the positioning of the urn base 11 adjacent to the rear enclosure section 5 allows the urn enclosure 1 to be angled as desired.

As can be seen in FIGS. 1 through 10, the flat bottom surface 12 is positioned opposite to the lower enclosure section 3 about the urn base 11 according to the overall thickness of the urn base 11. The base channel 13 also traverses from the flat bottom surface 12, through the urn base 11, and into the urn enclosure 1. This forms a through hole large enough to allow the flow of the cremated remains through the urn base 11 and into the urn enclosure 1 when the cremation urn is being filled. Further, the transverse plane 6 of the urn enclosure 1 is oriented at an acute angle 15 with the flat bottom surface 12 to allow the ornamental design of the urn enclosure 1 to be easily seen by the user. Furthermore, the urn hatch 14 is hermetically mounted into the base channel 13, adjacent to the flat bottom surface 12, to seal the base channel 13. This prevents the accidental leak of the cremated remains stored within the urn enclosure 1. In other embodiments, the present invention can be altered to accommodate different ornamental designs and/or functional features.

As previously discussed, the urn hatch 14 is designed to keep the stored cremated remains sealed within the urn enclosure 1. As can be seen in FIGS. 1 through 10, to facilitate the hermetic sealing of the base channel 13, the present invention may further comprise a hatch-attachment mechanism 16. The hatch-attachment mechanism 16 is designed to enable the manual fastening of the urn hatch 14 to the urn base 11 without the use of external tools or fasteners. So, the urn hatch 14 is mounted into the base channel 13 by the hatch-attachment mechanism 16 to form a hermetic seal that prevents the leaking of the stored cremated remains.

In the preferred embodiment, the hatch-attachment mechanism 16 comprises a male threading 17 and a female threading 18 that enable the manual attachment of the urn hatch 14 to the urn base 11. As can be seen in FIGS. 1 through 10, to implement this embodiment of the hatch-attachment mechanism 16, the male threading 17 is laterally connected around the urn hatch 14 to integrate the male threading 17 on the outer lateral surfaces of the urn hatch 14. On the other hand, the female threading 18 is connected around and within the base channel 13, adjacent to the flat bottom surface 12, to integrate the female threading 18 on the inner lateral surfaces of the base channel 13. Thus, to attach the urn hatch 14 to the base channel 13, the user engages the male threading 17 into the female threading 18 by rotating the urn hatch 14 into the base channel 13. This allows the urn hatch 14 to be flushed with the flat bottom surface 12 so that the urn base 11 sits flat on the desired surface. In other embodiments, different mechanisms can be implemented for the hatch-attachment mechanism 16.

As previously discussed, the urn hatch 14 is designed to be manually engaged by the user. As can be seen in FIGS. 1 through 10, to facilitate the manual engagement of the urn hatch 14, the present invention may further comprise a hatch handle 19 that allows the user to engage the urn hatch 14 using one hand. The hatch handle 19 is positioned external to the base channel 13 so that the hatch handle 19 is accessible to the user. In addition, the hatch handle 19 is centrally integrated across the urn hatch 14 to enable the user to easily manipulate the urn hatch 14. The hatch handle 19 is also designed so that the hatch handle 19 does not protrude past the overall thickness of the urn hatch 14. This way, when the present invention is placed on a surface, the flat bottom surface 12 sits flat on the surface. In other embodiments, the urn hatch 14 can include other physical features that facilitate the manual engagement of the urn hatch 14 singlehandedly.

In some embodiments, the urn base 11 can include protective features that protect the flat bottom surface 12 or the surface on which the urn base 11 rests. As can be seen in FIGS. 1 through 10, the urn base 11 may further comprise an external surface layer 20. The external surface layer 20 may be made of different materials that provide different functional benefits to the cremation urn with tilted display. For example, the external surface layer 20 can be made of a surface-protectant material that prevents damage to either the flat bottom surface 12 or the surface on which the urn base 11 is placed. The external surface layer 20 can also be made of a friction-increasing material that helps keep the cremation urn in place. In general, the external surface layer 20 is coextensive with the flat bottom surface 12 so that the external surface layer 20 covers all the flat bottom surface 12. The external surface layer 20 is also positioned around the base channel 13 to not block the opening of the base channel 13. Further, the external surface layer 20 is superimposed across the flat bottom surface 12 to secure the external surface layer 20 to the flat bottom surface 12. In other embodiments, different protective features can be implemented on the urn base 11 or around the urn enclosure 1.

As previously discussed, the present invention can include different ornamental features according to the overall design of the cremation urn. In some embodiments, the urn enclosure 1 may further comprise an ornamental surface 21 that adorns the upper enclosure section 2, as can be seen in FIGS. 1 through 10. The ornamental surface 21 can include different ornamental decorations including, but not limited to, a photograph, a painting, an engraving, etc. For example, at least one printed graphic 10 can be inscribed into the ornamental surface 21 using the appropriate mechanisms. The ornamental surface 21 can also be shaped to match the shape of the urn enclosure 1 or the upper enclosure section 2. The ornamental surface 21 is preferably centrally connected onto the upper enclosure section 2. However, the ornamental surface 21 may be coextensive with the entire upper enclosure section 2 so that the corresponding ornamental decorations span the surface of the upper enclosure section 2.

In some embodiments, the urn enclosure 1 may further comprise a translucent protective layer 9 that covers and protects the ornamental decorations of the ornamental surface 21. As can be seen in FIGS. 1 through 10, the translucent protective layer 9 can be made of different materials including, but not limited to, plastic, paint coating, acrylic, epoxy, etc. So, the translucent protective layer 9 is coextensive with the ornamental surface 21 so that the translucent protective layer 9 covers the entire ornamental surface 21. In addition, the translucent protective layer 9 is superimposed across the ornamental surface 21, opposite to the upper enclosure section 2, so that the ornamental decorations of the ornamental surface 21 are covered by the translucent protective layer 9. In other embodiments, different protective materials and/or components can be implemented to protect ornamental decorations on the different sections of the urn enclosure 1 and/or the urn base 11.

Although the invention has been explained in relation to its preferred embodiment, it is to be understood that many other possible modifications and variations can be made without departing from the spirit and scope of the invention.

What is claimed is:

1. A cremation urn with tilted display comprising:
an urn enclosure;
an urn base;
an urn hatch;
the urn enclosure comprising an upper enclosure section, a lower enclosure section, a front enclosure section, and a rear enclosure section;
the urn base comprising a flat bottom surface and a base channel;
the upper enclosure section and the lower enclosure section being positioned opposite to each other about a transverse plane of the urn enclosure;
the front enclosure section and the rear enclosure section being positioned opposite to each other about a coronal plane of the urn enclosure;
the urn base being integrated into the lower enclosure section, adjacent to the rear enclosure section;
the flat bottom surface being positioned opposite to the lower enclosure section about the urn base;
the base channel traversing from the flat bottom surface, through the urn base, and into the urn enclosure;
the transverse plane of the urn enclosure being oriented at an acute angle with the flat bottom surface; and
the urn hatch being hermetically mounted into the base channel, adjacent to the flat bottom surface.

2. The cremation urn with tilted display as claimed in claim 1 further comprising:
a hatch-attachment mechanism; and
the urn hatch being mounted into the base channel by the hatch-attachment mechanism.

3. The cremation urn with tilted display as claimed in claim 2 further comprising:
the hatch-attachment mechanism comprising a male threading and a female threading;
the male threading being laterally connected around the urn hatch; and
the female threading being connected around and within the base channel, adjacent to the flat bottom surface.

4. The cremation urn with tilted display as claimed in claim 1 further comprising:
a hatch handle;
the hatch handle being positioned external to the base channel; and
the hatch handle being centrally integrated across the urn hatch.

5. The cremation urn with tilted display as claimed in claim 1 further comprising:
the urn base further comprising an external surface layer;
the external surface layer being coextensive with the flat bottom surface;
the external surface layer being positioned around the base channel; and
the external surface layer being superimposed across the flat bottom surface.

6. The cremation urn with tilted display as claimed in claim 5, wherein the external surface layer is made of a surface-protectant material.

7. The cremation urn with tilted display as claimed in claim 5, wherein the external surface layer is made of a friction-increasing material.

8. The cremation urn with tilted display as claimed in claim 1 further comprising:
the urn enclosure further comprising an ornamental surface; and
the ornamental surface being centrally connected onto the upper enclosure section.

9. The cremation urn with tilted display as claimed in claim 8 further comprising:
the urn enclosure further comprising a translucent protective layer;
the translucent protective layer being coextensive with the ornamental surface; and
the translucent protective layer being superimposed across the ornamental surface, opposite to the upper enclosure section.

10. The cremation urn with tilted display as claimed in claim 8 further comprising:
the urn enclosure further comprising at least one printed graphic; and
the at least one printed graphic being inscribed into the ornamental surface.

11. The cremation urn with tilted display as claimed in claim 1, wherein the urn enclosure is a heart-shaped enclosure bisected by a sagittal plane of the urn enclosure.

12. A cremation urn with tilted display comprising:
an urn enclosure;
an urn base;
an urn hatch;
a hatch-attachment mechanism;
the urn enclosure comprising an upper enclosure section, a lower enclosure section, a front enclosure section, and a rear enclosure section;
the urn base comprising a flat bottom surface and a base channel;
the upper enclosure section and the lower enclosure section being positioned opposite to each other about a transverse plane of the urn enclosure;
the front enclosure section and the rear enclosure section being positioned opposite to each other about a coronal plane of the urn enclosure;
the urn base being integrated into the lower enclosure section, adjacent to the rear enclosure section;
the flat bottom surface being positioned opposite to the lower enclosure section about the urn base;
the base channel traversing from the flat bottom surface, through the urn base, and into the urn enclosure;
the transverse plane of the urn enclosure being oriented at an acute angle with the flat bottom surface; and
the urn hatch being hermetically mounted into the base channel by the hatch-attachment mechanism, adjacent to the flat bottom surface.

13. The cremation urn with tilted display as claimed in claim 12 further comprising:
the hatch-attachment mechanism comprising a male threading and a female threading;
the male threading being laterally connected around the urn hatch; and
the female threading being connected around and within the base channel, adjacent to the flat bottom surface.

14. The cremation urn with tilted display as claimed in claim 12 further comprising:
a hatch handle;
the hatch handle being positioned external to the base channel; and
the hatch handle being centrally integrated across the urn hatch.

15. The cremation urn with tilted display as claimed in claim 12 further comprising:
the urn base further comprising an external surface layer;
the external surface layer being coextensive with the flat bottom surface;
the external surface layer being positioned around the base channel; and
the external surface layer being superimposed across the flat bottom surface.

16. The cremation urn with tilted display as claimed in claim 15, wherein the external surface layer is made of a surface-protectant material.

17. The cremation urn with tilted display as claimed in claim 15, wherein the external surface layer is made of a friction-increasing material.

18. The cremation urn with tilted display as claimed in claim 12 further comprising:
the urn enclosure further comprising an ornamental surface and a translucent protective layer;
the ornamental surface being centrally connected onto the upper enclosure section;
the translucent protective layer being coextensive with the ornamental surface; and
the translucent protective layer being superimposed across the ornamental surface, opposite to the upper enclosure section.

19. The cremation urn with tilted display as claimed in claim 18 further comprising:
the urn enclosure further comprising at least one printed graphic; and
the at least one printed graphic being inscribed into the ornamental surface.

20. The cremation urn with tilted display as claimed in claim 12, wherein the urn enclosure is a heart-shaped enclosure bisected by a sagittal plane of the urn enclosure.
